(19) United States
(12) Patent Application Publication
(10) Pub. No.: US 2021/0178891 A1
(43) Pub. Date: Jun. 17, 2021

(54) POWER TRANSMISSION STRUCTURE FOR HYBRID VEHICLE COMPRISING TWO MOTOR GENERATORS AND THREE CLUTCHES

(71) Applicants: Myungkoo KANG, Busan (KR); Hyo Jung JEON, Busan (KR); Seungmo KANG, Busan (KR); Soo Jung KANG, Busan (KR)

(72) Inventors: Myungkoo KANG, Busan (KR); Hyo Jung JEON, Busan (KR); Seungmo KANG, Busan (KR); Soo Jung KANG, Busan (KR)

(21) Appl. No.: 16/074,263

(22) PCT Filed: Jun. 20, 2016
(86) PCT No.: PCT/KR2016/006521

§ 371 Date: Jul. 31, 2018

(30) Foreign Application Priority Data
May 16, 2016 (KR) 10-2016-0059590

(51) Int. Cl. B60K 6/48; B60K 6/387

(52) U.S. Cl. CPC B60K 6/48; B60K 6/26; B60K 6/387

(57) ABSTRACT

A power transmission structure for a hybrid vehicle having two motor generators and three clutches includes: an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of a motor (30), a first clutch (111) and a second clutch (112) constituting a double clutch are disposed on the output shaft (40) between the engine (10) and the second motor (20), and a third clutch (113) is disposed between the second motor (20) and the first motor (50).

### TECHNICAL FIELD

The present invention relates to a power transmission structure of a hybrid vehicle and, more particularly, a power transmission system for a hybrid vehicle, the power transmission system including an engine and two motors, which are power sources of the vehicle, and three clutches and being able to achieve optimal performance and fuel efficiency in accordance with the driving status of the vehicle by selectively transmitting power from the power sources to a transmission.

### BACKGROUND ART

Recently, the automotive industrial field is considerably interested in development of a hybrid vehicle that is more eco-friendly and can improve fuel efficiency. A hybrid vehicle uses two or more power sources and is generally driven by an internal combustion engine and a motor/generator (hereafter, referred to as a motor) that are power sources.

The power transmission systems of hybrid vehicle using an engine and a motor can be largely classified into a type that uses a single motor and a type that uses two motors. As common vehicles using a single motor, there are SONATA hybrid and IONIQ hybrid by Hyundai, hybrids by Nissan, hybrids by Audi, etc., and as common vehicle using two motors, there are Accord hybrid by Honda, Prius by Toyota, Bolt by Chevrolet etc.

As compared with the case that uses one motor, when two motors are used to drive a vehicle, not only there is a need for separate circuits and PCUs for respectively controlling the two motors, but the manufacturing cost is increased and the vehicle body becomes heavy. However, it is possible to drive the vehicle with one motor and generate electricity with the other motor, which is called a real time series mode, which is advantageous in terms of function.

However, in all the hybrid vehicles of the related art, once batteries are fully discharged, motors that cannot be operated become a passive load on an engine, so the power from the engine is considerably reduced than it is known. To this end, hybrid vehicles use a method of charging batteries in advance by generating electricity at all times, but in reality the batteries cannot be recharged and are fully discharged, depending on the driving status of vehicles, unless a large-capacity battery is mounted. If the batteries are forcibly charged, a vicious cycle in which the fuel efficiency and performance are reduced is repeated, so there is a need for corrective measures.

### DISCLOSURE

### Technical Problem

The present invention has been made in an effort to solve the problems and an object of the present invention is to provide a power transmission structure for a hybrid vehicle, the power transmission structure being able to keep the advantage when electricity remains in a battery and can minimize the disadvantage when a battery is fully discharged.

### Technical Solution

A power transmission structure for a hybrid vehicle having two motor generators and three clutches according to an aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a first clutch (111) and a second clutch (112) constituting a double clutch are disposed on the output shaft (40) between the engine (10) and the second motor (20), and a third clutch (113) connecting or disconnecting power transmitted through the output shaft (40) is disposed between the second motor (20) and the first motor (50).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a second clutch (112) and a first clutch (111) constituting a double clutch are disposed on the output shaft (40) between the second motor (20) and the first motor (50), and a third clutch (113) connecting or disconnecting power transmitted through the output shaft (40) is disposed between the engine (10) and the second motor (20).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a second clutch (112) and a first clutch (111) constituting a dual clutch are disposed on the output shaft (40) between the second motor (20) and the transmission (30), and a third clutch (113) connecting or disconnecting power transmitted through the output shaft (40) is disposed between the dual clutch and the first motor (50).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft of the transmission (30) is disposed between the second motor (20) and the transmission (30), the output shaft (40) is connected to the transmission (30) through a center of the second motor (20), a first clutch (111) and a second clutch (112) constituting any one of a dual clutch and a double clutch are disposed between the engine (10) and the second motor (20), and a third clutch (113) connecting or disconnecting power generated by the second motor (20) and transmitted through the output shaft (40) is disposed on the output shaft (40) between the second motor (20) and the first motor (50).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a first clutch (111) and a second clutch (112) constituting a dual clutch are disposed on the output shaft (40) between the engine (10) and the second motor, and a third clutch (113) is disposed on the output shaft between the engine (10) and the dual clutch.

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a third clutch (113) is disposed between the engine (10) and the second motor (20), and a second clutch (112) and a first clutch (111) constituting one of a dual clutch and a double clutch is disposed on the output shaft (40) between the second motor (20) and the first motor (50).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), and a first clutch (211), a second clutch (212), and a third clutch (213) constituting a triple clutch are disposed on the output shaft between the engine (10) and the second motor (20).

A power transmission structure for a hybrid vehicle having two motor generators and three clutches according to another aspect of the present invention includes an engine (10), a second motor (20), and an output shaft (40) transmitting power from the engine (10) and the second motor (20) to a transmission (30), in which the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), and a third clutch (213), a second clutch (212), and a first clutch (211) constituting a triple clutch are disposed on the output shaft between the second motor (20) and the first motor (50).

### Advantageous Effects

According to the present invention, as compared with hybrid vehicles of the related art, it is possible to minimize driven load by driving motors that may reduce the output of an engine when a vehicle is driven only by an engine, and it is also possible to selectively use a motor having larger capacity from two motors or both of the two motors when additional output is needed when additional output is required such as high-speed driving or accelerating in a motor mode.

Furthermore, according to the present invention, it is possible to drive a vehicle only with a first motor at a low speed in a motor mode and to drive a vehicle using any one or both of a first motor and a second motor at a high speed, whereby it is possible to improve the fuel efficiency (km/kw) of an electric vehicle in a motor mode.

Furthermore, it is possible to add power from one or both of a first motor and a second motor in a parallel mode and it is also possible to apply a real time series mode in which the second motor of the first motor and the second motor generates electricity by an engine and a vehicle is driven only by the first motor.

### DESCRIPTION OF DRAWINGS

FIG. 1 is a view schematically showing a configuration of a power transmission structure for a hybrid vehicle according to the present invention;

FIG. 2 is a view schematically showing another configuration of a power transmission structure for a hybrid vehicle according to the present invention;

FIG. 3 is a view schematically showing another configuration of a power transmission structure for a hybrid vehicle according to the present invention;

FIG. 4 is a view schematically showing another configuration of a power transmission structure for a hybrid vehicle according to the present invention;

FIG. 5 is a view schematically showing another configuration of a power transmission structure for a hybrid vehicle according to the present invention;

FIG. 6 is a view schematically showing another configuration of a power transmission structure for a hybrid vehicle according to the present invention;

FIG. 7 is a view schematically showing another configuration of a power transmission structure for a hybrid vehicle according to the present invention; and

FIG. 8 is a view schematically showing another configuration of a power transmission structure for a hybrid vehicle according to the present invention.

### DESCRIPTION OF THE REFERENCE NUMERALS IN THE DRAWINGS

| | |
|---|---|
| 10: Engine | 20: Second motor |
| 30: Transmission | 40: Output shaft |
| 50: First motor | 111, 211: First clutch |
| 112, 212: Second clutch | 113, 213: Third clutch |

### BEST MODE

Exemplary embodiments of the present invention are described hereafter in detail with reference to the accompanying drawings. In the following description of exemplary embodiments of the present invention, configurations that are not directly in associated with the technical features of the present invention or that are apparent to those skilled in the art will not be described in detail.

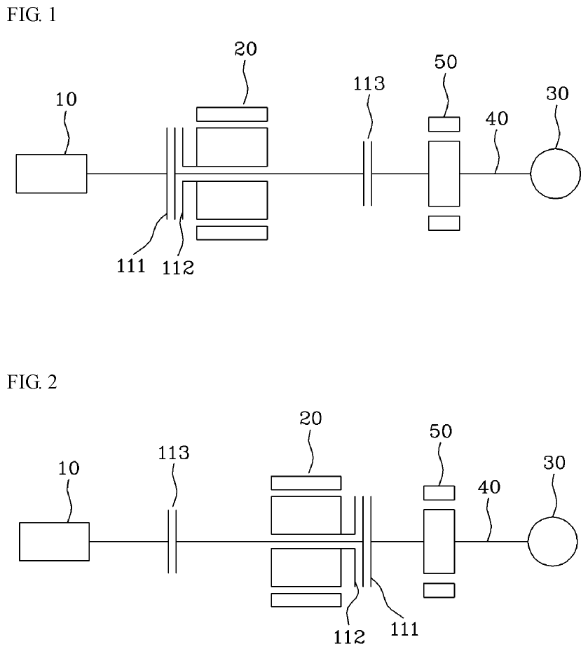

FIGS. 1 to 8 are views schematically showing configurations of a power transmission structure for a hybrid vehicle according to the present invention. As shown in the figures, the power transmission structure is technically characterized by including an engine 10, a second motor 20, a first motor 50, a transmission 30, an output shaft 40, and first and second clutch 111 and 112 and a third clutch 113 or a triple clutch. These components are described in detail.

The engine 10, which is an internal combustion engine that is generally used in the art, may be a piston engine. Through not shown in the figures, the present invention does not exclude a case providing a low-voltage starter of 12V at a side of the engine 10. The 12V starter does not need a separate high-voltage electrical connection unit or a separate control unit, unlike a high-voltage starter generator.

The second motor 20, which is a high-voltage motor generator that is generally used in the art, is a device that generates power by consuming electricity or generates electricity by receiving power. The second motor 20 is disposed at a predetermined distance from and in parallel with the engine 10 and has a hollow rotary shaft.

That is, an output shaft 40 connected to the engine 10 is disposed through the second motor 20. This is for preventing some of power generated by the engine and transmitted to the output shaft 40 from losing due to the second motor 20. When a clutch is operated, the power from the second motor is connected or disconnected. According to this configuration, a motor having large capacity relative to the engine displacement can be mounted in the present invention.

The second motor 20 is connected to a battery (not shown) and generates power by consuming the electricity accumulated in the battery. The motor may be any one of various motors that can be used to drive a vehicle and may be configured to operate as a power generator in an engine electricity generation mode or a regenerative mode.

The first motor 50, which is a device complementing the operation of the second motor 20, may be a high-voltage motor generator that is generally used in the art. In the present invention, the first motor 50 is directly connected to the transmission 30, so the first motor 50 can function as a load when the engine 10 is operated.

In consideration of this, the capacity of the first motor 50 is appropriately determined relative to the capacity of the engine to be mounted such that a driven load when a vehicle is driven only by an engine and the first motor 50 is not operated and forcibly rotated without generating electricity can be minimized and independent electric vehicle mode driving or series mode driving is possible only by the first motor 50 in high constant-speed driving. The capacity of the first motor 50 may be smaller than the capacity of the second motor 20.

The capacity of the second motor 20 may be set such that maximally efficient engine electricity generation is possible relative to the capacity of the engine to be mounted (maximum electricity generation efficiency=maximum amount of electricity generation/amount of fuel consumption at predetermined number of revolutions) and the capacity of the second motor 20 may be set to be larger than the capacity of the first motor 50 and to be able to achieve maximum engine electricity generation efficiency.

In hybrid vehicles (Prius and Bolt) that are mainly driven in a series mode using two motors in the related art, the capacity of the first motor connected to a transmission is close to a double of the capacity of the second motor connected to an engine, because, in most cases, the vehicles are driven only by the first motor and the second motor is generally used to generate electricity by operating the engine. This is because driving that uses only the engine (two motors stopped) is applied only to high constant-speed driving. In this case, it is advantageous in terms of the series mode, but is disadvantageous in terms of the engine mode. Accordingly, according to these hybrid vehicles, the fuel efficiency is higher in cities and lower in high-speed driving.

That is, the performance of the hybrid vehicles using two motors in the related art is low in performance in high constant-speed driving and high accelerating, in comparison to vehicles using only an engine in the related art, so they are suitable for driving in cities or driving a long distance at medium speeds. Furthermore, a motor is usually used to drive the vehicles, so when a vehicle is driven only by an engine, it is required to charge the battery at all times by generating electricity, depending on the status of the output from the engine, in order to reduce the defect when the battery is fully discharged. Accordingly, these vehicle are advantageous in terms of fuel efficiency, but have a limit in terms of performance, so the vehicles is difficult to be used as sports cars or luxury cars.

However, according to the present invention, when the capacity of the first motor is set within a range in which motor mode driving is possibly only by the first motor 50 in high constant-speed driving with a high gear, which can maximally achieve the advantage of parallel hybrid, engaged, a driven load by the first motor when a vehicle is driven only by an engine and the output from the first motor and the second motor can be increased, so the motor power performance is sufficient to drive the vehicle. Furthermore, the fuel efficiency (Km/Kw) in an electric vehicle mode can be improved.

The transmission 30 appropriately controls and transmits power, which is generated by the engine 10 and (or) the second motor 20 and the driving motor 50 to transmitted through the output shaft 40, to wheels (not shown). The transmission 30 may be any one of a CVT, a toroidal CVT, an AT, and a DCT and the configuration connecting the transmission and the output can be slightly changed, depending on the types of transmissions to be mounted. This means that since the CVT does not have a neutral position, the single clutch at the transmission in the drawings is necessary, while, since the AT and DCT has a neutral position, the single clutch at the transmission can be removed.

The first and second clutches 111 and 112 and the third clutch 113 or the triple clutch according to the present invention can be arranged, as shown in FIGS. 1 to 8, and the power transmission processes by the clutches are described in detail.

First, as shown in FIG. 1, the first and second clutches 111 and 112 may be disposed on the output shaft 40 between the engine 10 and the second motor 20 and the third clutch 113 may be disposed on the output shaft 40 between the second motor 20 and the first motor 50. The first and second clutches 111 and 112 constitute a double clutch and are disposed at a first side, which faces the engine 10, of the second motor 20.

In this case, when the output end of the engine 10 is connected to the output shaft 40 by operating the first clutch 111 with the third clutch 113 engaged, the power from the engine 10 (or power from the engine and an auxiliary motor) is transmitted to the transmission 30. Furthermore, when the output end of the second motor 20 (the rotary shaft of the motor, which is the same in the following description) is connected to the output shaft 40 by operating the second clutch 112, the power from the second motor 20 (or the motor from the second motor and the first motor) is transmitted to the transmission 30 or is used for regenerative electricity generation.

Furthermore, the output end of the engine 10 and the output end of the second motor 20 are connected to the output shaft 40 by operating both of the first and second clutches 111 and 112, the power from the engine 10 and the second motor 20 (or the power from the engine, the second motor, and the first motor) is transmitted to the transmission 30. Alternatively, when the output end of the engine 10 is connected to the output end of the second motor 20 by operating the first and second clutches 111 and 112 with the third clutch 113 disengaged, the power from the engine 10 is fully transmitted to the second motor 20, so the engine electricity generation efficiency becomes maximum. Furthermore, the engine 10 can be started by operating the second motor 20.

Next, as shown in FIG. 2, the second and first clutches 112 and 111 may be disposed on the output shaft 40 between the second motor 20 and the first motor 50 and the third clutch 113 may be disposed on the output shaft 40 between the engine 10 and the second motor 20. The second clutch 112 and the first clutch 111 constitute a double clutch and are disposed at the other side, which faces the first motor 50, of the second motor 20. In FIG. 2, power transmission by the first, second, and third clutches 111, 112, and 113 is almost the same as that in FIG. 1.

Next, as shown in FIG. 3, the second, first, and third clutches 112, 111, and 113 may be all disposed on the output shaft 40 between the second motor 20 and the first motor 50. In detail, the second and third clutches 112 and 111 may be disposed at the side, which faces the first motor 50, of the second motor 20 and the third clutch 113 may be disposed between the second and first clutches 112 and 111 and the first motor 50. The second and first clutches 112 and 111 constitute a double clutch.

In the cases shown in FIGS. 1 and 2, both sides of each of the first and second clutches 111 and 112 are used to connect/disconnect a contact point, but in the case shown in FIG. 3, one side of each of the second and first clutches 112 and 111 is used to connect/disconnect a contact point. Technology related to this is well known in the art, so the detailed description is not provided. In FIG. 3, power transmission by the second, first, and third clutches 112, 111, and 113 is almost the same as that in FIG. 1.

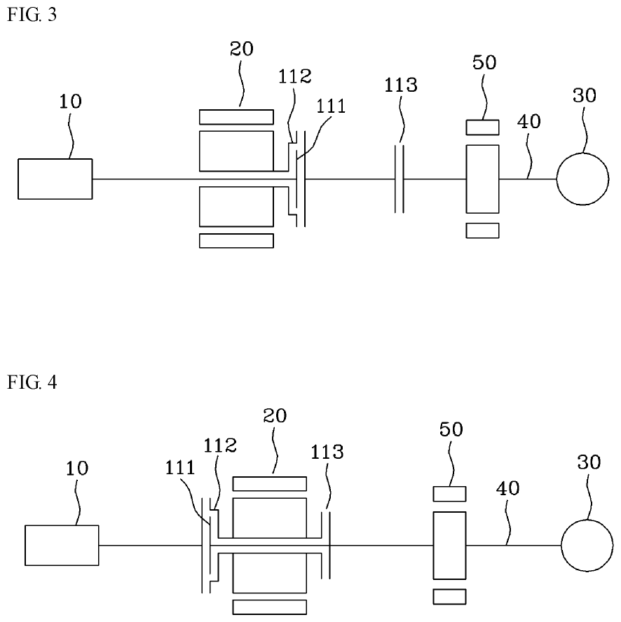

Next, as shown in FIG. 4, the first and second clutches 111 and 112 may be disposed on the output shaft 40 between the engine 10 and the second motor 20 and the third clutch 113 may be disposed on the output shaft 40 between the second motor 20 and the first motor 50. This configuration is similar to the configuration shown in FIG. 1, but is different in that the power that is connected/disconnected by the third clutch 113 is the power that is generated by the second motor 20 and transmitted to the output shaft 40. The first and second clutches 111 and 112 may constitute any one of a double clutch and a dual clutch.

When the output end of the engine 10 is connected to the output shaft 40 by operating the first clutch 111 with the third clutch 113 disengaged, the power from the engine 10 is transmitted to the transmission 30. Furthermore, when the first and second clutches 111 and 112 are engaged, the power from the engine 10 is transmitted to the transmission 30 through the second motor 20. In this process, the third clutch 113 has been disengaged. Furthermore, when the output end of the engine 10 is connected to the input end of the second motor 20 (the left side of the second motor 20 in the figure) by engaging only the second clutch 112 with the third clutch 113 disengaged, power can be generated by operating the second motor 20 using the engine 10 or the engine 10 can be started by the second motor 20.

Alternatively, when the output end of the second motor 20 (the right side of the second motor 20 in the figure) is connected to the output shaft 40 by operating the third clutch 113 without the first and second clutches 111 and 112 operated, the power from the second motor 20 is transmitted to the transmission 30 and the vehicle can be driven or regenerative electricity generation in deceleration is possible. Furthermore, the output end of the engine 10 and the output end of the second motor 20 are connected to the output shaft 40 by operating the first and third clutches 111 and 113, the power from the engine 10 and the second motor 20 is transmitted to the transmission 30. In this process, the second clutch 112 is disengaged.

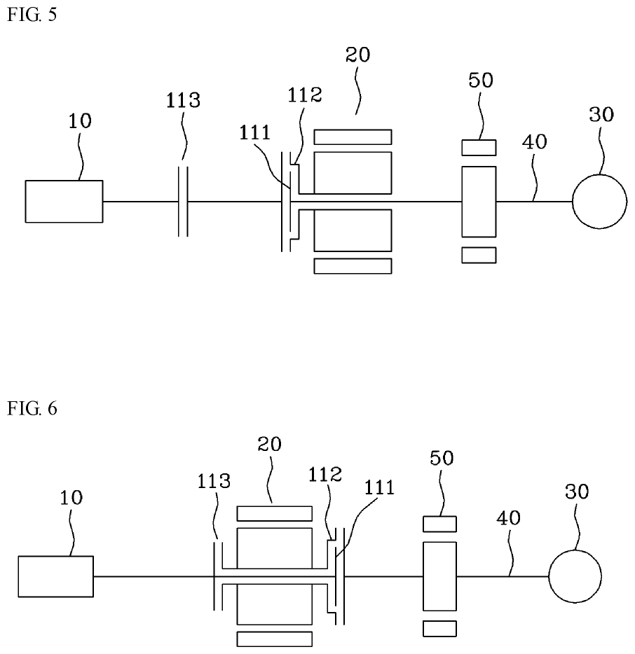

Next, as shown in FIG. 5, the third, first, and second clutches 113, 111, and 112 may be disposed between the engine 10 and the second motor 20. The configuration shown in FIG. 5 is similar to the configuration shown in FIG. 3, but is different in that the first and second clutches 111 and 112 are disposed between the third clutch 113 and the second motor 20. The first and second clutches 111 and 112 are disposed at a first side, which faces the third clutch 113, of the second motor 20 and may constitute a dual clutch.

In this case, when the output end of the engine 10 is connected to the output shaft 40 by operating the first clutch 111 with the third clutch 113 engaged, the power from the engine 10 is transmitted to the transmission 30. Furthermore, when the output end of the engine 10 and the output end of the second motor 20 are connected to the output shaft 40 by operating both of the first clutch 111 and the second clutch 112, the power from the engine 10 and the second motor 20 is transmitted to the transmission 30.

Alternatively, when the output end of the engine 10 and the output end of the second motor 20 are connected to each other and the first clutch 111 is disengaged with the third clutch 113 engaged, the power from the engine 10 is fully transmitted to the second motor 20, so power can be generated or the engine 10 can be started by operating the second motor 20. If the output end of the second motor 20 is connected to the output shaft 40 by operating the first and second clutches 111 and 112 with the third clutch 130 disengaged, the power from the second motor 20 is transmitted to the transmission 30 or is used for regenerative electricity generation.

Next, as shown in FIG. 6, the third clutch 113 may be disposed on the output shaft 40 between the engine 10 and the second motor 20 and the second and first clutches 112 and 111 may be disposed on the output shaft 40 between the second motor 20 and the first motor 50. The second and first clutches 112 and 111 may constitute any one of a double clutch and a dual clutch. There is a different between FIGS. 6 and 4 in that the positions of the first and second clutches 111 and 112 and the third clutch 113 are different.

In FIG. 6, the third clutch 113 connects/disconnects a contact point between the input end of the second motor 20 (the left side of the motor 20 in FIG. 6) and the output shaft of the engine 10. That is, when the third clutch 113 is operated with the output end of the engine 10 and the output end of the second motor 20 disconnected from the output shaft (the first and second clutches 111 and 112 disengaged), the power from the engine 10 is transmitted to the second motor 20 through the input end of the second motor 20 and is used for electricity generation or is used to operate the second motor 20 and the engine 10 can be started. The operation mechanism of the second and first clutches 112 and 111 as a dual clutch except for the above description is almost the same as that described above with reference to FIG. 4.

Next, as shown in FIG. 7, a first clutch 211, a second clutch 212, and a third clutch 213 may be disposed, as a triple clutch, between the engine 10 and the second motor 20, in which the triple clutch may be disposed at a first side, which faces the engine 10, of the second motor 20. Unlike FIGS. 1 to 6, the configuration shown in FIG. 7 is characterized by controlling power transmission using a single clutch structure.

When the output of the engine 10 is connected to the output shaft 40 by operating the first clutch 211, the power from the engine 10 is transmitted to the transmission 30 through the output shaft 40. Alternatively, when the output end of the second motor 20 is connected to the output shaft 40 by operating the second clutch 212 with the third clutch 211 disengaged, the power from the second motor 20 is transmitted to the transmission 30 or is used for regenerative electricity generation.

Furthermore, when any one of the second clutch 211 and the third clutch 213 is engaged with the first clutch 211, the power from the engine 10 and the second motor 20 is transmitted to the transmission 30. If the output end of the engine 10 is connected to the output end of the second motor 20 by operating only the third clutch 113 with the first and second clutches 211 and 212 disengaged, the power from the engine 10 is fully transmitted to the second motor 20 and is used to generate electricity. Furthermore, the engine 10 can be started by operating the second motor 20.

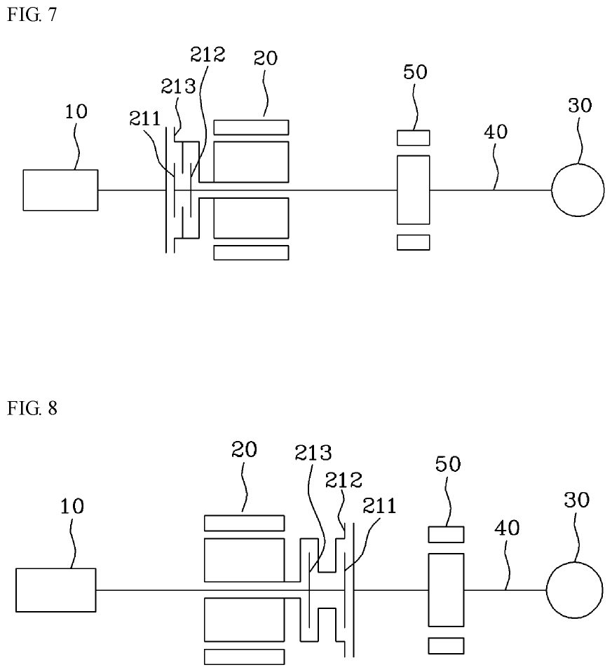

Furthermore, the third, second, and first clutches 213, 222, and 211 constituting a triple clutch may be disposed between the second motor 20 and the first motor 50, as shown in FIG. 8, in which the triple clutch may be disposed at a second side, which faces the first motor 50, of the second motor 20. In this case, when the output end of the engine 10 is connected to the output shaft 40 by operating the first clutch 211, the power from the engine 10 is transmitted to the transmission 30 through the output shaft 40. Furthermore, when the output end of the second motor 20 connected to the output shaft 40 by operating the second clutch 212 with the first clutch 211 disengaged, the power from the engine 20 is transmitted to the transmission 30 or is used for regenerative electricity generation.

Furthermore, when any one of the second clutch 211 and the third clutch 213 is engaged with the first clutch 211, the power from the engine 10 and the second motor 20 is transmitted to the transmission 30. Furthermore, when the output end of the engine 10 is connected to the output end of the second motor 20 by operating only the third clutch 213 with the first and second clutches 211 and 212 disengaged, the power from the engine 10 is fully transmitted to the second motor 20 and is used to generate electricity or is used to start the engine 10 by operating the second motor 20.

The clutches that are applied to the present invention may be fundamentally wet clutches, but other various clutches that are generally used in the art can also be applied. That is, the clutch disposed at a side of an engine may be a dry clutch, and the clutch disposed at a side of a motor and the clutch disposed at a side of a transmission may be a magnetic clutch.

In particular, the clutch disposed at a side of a motor generator should be disengaged when a vehicle is driven only by an engine and should be connected in regenerative electricity generation or electricity generation by an engine, in which the numbers of revolutions should be synchronized to reduce contact shock. An electronic magnetic clutch is advantageous in this synchronization. However, even if a wet clutch is used, synchronization can be easily achieved by controlling the number of revolutions of a motor before contact, so a wet clutch can be applied.

Meanwhile, though not clearly shown in the drawings, the present invention does not exclude a case in which a planetary gear is disposed around the output end or the input end of a motor, as shown in FIGS. 5a to 5d in Korean Patent No. 1580773 by the applicant(s). When a planetary gear is provided, a motor can maximally generate electricity using input power, so the fuel efficiency of an engine can be improved and the efficiency of the regenerative power generation can also be improved.

Connection of an engine, a second motor, and a first motor for each driving mode when there are provided a second motor and a first motor, and first, second, and third clutches or a triple clutch, as in the present invention, is described hereafter.

Motor Mode

A vehicle is driven by operating the second motor 20 and (or) the first motor 50 without operating the engine 10. That is, three driving states of independently operating any one of the second motor 20 and the first motor 50 and both of the second motor 20 and the first motor 50 are possible. In this mode, the engine 10 is not connected to the output shaft 40 by disengaging the clutch close to the engine 10 (111 in FIGS. 1, 3, 4, and 6, 113 in FIG. 5, and 211 in FIGS. 7 and 8).

Furthermore, when it is required to increase a speed or more output for acceleration is needed while a vehicle is driven only by the first motor, the second motor 20 is operated and synchronized in the number of revolutions with the first motor 50 and then a motor and an auxiliary motor are connected to be simultaneously operated. When a predetermined speed is reached and then the vehicle is driven at a constant speed, a high gear is engaged and the second motor 20 is stopped, so the vehicle can be driven only by the first motor 50. Furthermore, when electricity remains in a battery, the second motor 20 and the first motor 50 can be independently or simultaneously operated in high constant-speed driving, if necessary.

Series Mode

The engine 10 and the first motor 50 are operated, a vehicle is driven by the first motor 50, and the engine 10 is connected to the second motor 20 to generate electricity. In detail, the components 111 and 112 are operated for connection and the component 113 is disengaged in FIG. 1, the components 113 and 112 are operated for connection and the component 111 is disengaged in FIG. 2, and the components 111 and 112 are operated for connection and the component 113 is disengaged in FIG. 3.

Furthermore, the component 112 is operated for connection and the components 111 and 113 are disengaged in FIG. 4, the components 113 and 112 are operated for connection and the component 111 is disengaged in FIG. 5, the component 113 is operated for connection and the components 111 and 112 are disengaged in FIG. 6, and the component 213 is operated for connection and the components 211 and 212 are disengaged in FIGS. 7 and 8.

This function according to the present invention is a real time series mode, there is no configuration corresponding to this function in Korean Patent No. 1490917, and an electric vehicle mode operating a driving motor using electricity stored in a battery is provided, instead of this function of the present invention, in Korean Patent No. 1490917.

Parallel Mode

The engine 10 and the second motor 20 and (or) the first motor 50 are independently operated. The engine 10 and the second motor 20 is simultaneously operated, or the engine 10 and the first motor 50 are simultaneously operated, or the engine 10, the second motor 20, and the first motor 50 are simultaneously operated, thereby driving a vehicle.

When the engine 10 and the second motor 20 are simultaneously operated, the components 111, 112, and 113 are connected in FIGS. 1 to 3, and 5, and the component 111 is connected and any one of the components 112 and 113 is selectively connected in FIGS. 4 and 6. The component 211 is connected and any one of the components 212 and 213 is selectively connected in FIGS. 7 and 8. In this case, the first motor 50 is operated, but forcibly rotated.

When the engine 10 and the first motor 50 are simultaneously operated, the second motor 20 is not clutched. Furthermore, when the engine 10 and the first motor 50 are simultaneously operated and the second motor 20 is not operated, the second motor 20 is not clutched.

When the engine 10, the second motor 20, and the first motor 50 are simultaneously operated, the clutching state is the same, but there is a difference in that the first motor 50 is operated, as compared with the case in which the engine 10 and the second motor 20 are simultaneously operated.

Engine Mode

Only the engine 10 is independently operated, and the second motor 20 and the first motor 50 are not operated. The components 111 and 113 are connected in FIGS. 1 to 3, and 5, the component 111 is connected in FIGS. 4 and 6, and the component 211 is connected in FIGS. 7 and 8. The second motor 20 is not clutched and is not associated with the power transmission process, so there is no driven load, and the first motor 50 is only forcibly rotated without operating.

Regenerative Mode

When a vehicle is decelerated while driving in the motor mode, the first motor 50, or the second motor 20 and the first motor 50 can perform regenerative electricity generation, and when a vehicle is decelerated while driving in the engine mode, the first motor 50 can perform regenerative electricity generation and the second motor 20 can be connected to the engine 10, whereby electricity is generated by the engine. When the engine 10 is not operated, the first motor 50, or the second motor 20 and the first motor 50 can perform regenerative electricity generation.

Inertia Driving & Engine Electricity Generation Mode

A vehicle is coasted by inertia, in which the engine 10 and the second motor 20 are connected and electricity is generated by the engine. The clutch close to the engine has been disengaged. Regenerative electricity generation is not performed during coasting, so the first motor 50 is forcibly rotated without operating and performing regenerative electricity generation.

Stop & Engine Electricity Generation Mode

A vehicle is temporarily stopped, in which the engine 10 and the second motor 20 are connected and generate electricity.

Driving & Engine Electricity Generation Mode

A vehicle is driven by the engine, and any one or both of the first motor 50 and the second motor 20 can generate electricity, depending on the output state of the engine 10. That is, the output of the engine is insufficient for uphill driving, so a vehicle can be driven without the engine generating electricity or any one or both of the first motor and the second motor can help drive the vehicle. Furthermore, the output of the engine is sufficient in constant-speed driving or downhill driving, so electricity can be generated by any one of the types described above, depending on the output state of the engine.

The most ideal operation configuration according to the driving state of a vehicle is described by combining the driving modes of the present invention.

First, when a vehicle that has been stopped is started, the first motor 50 is used to start the vehicle if there is electricity remaining in the battery or, the vehicle is driven only by the engine 10 or electricity is generated by connecting the engine 10 and the second motor 20 to each other and the vehicle is driven in the real time series mode by the first motor 50 if there is no electricity remaining in the battery.

When the speed of the vehicle exceeds a predetermined value, the vehicle is driven in the motor mode by operating both of the second motor 20 and the first motor 50 if there is electricity remaining in the battery, and the vehicle is driven by the engine 10 if there is no electricity remaining in the battery. In this case, there is no driven load by the second motor 20. When the vehicle needs to be accelerated, any one of the parallel modes can be applied, in which if there is no electricity remaining in the battery, the vehicle may be driven only by the engine.

When the vehicle is driven at a high constant speed, the vehicle is driven by the first motor 50 if there is electricity remaining in the battery and, the vehicle is driven only by the engine or may be driven by the first motor 50 with the second motor 20 generating electricity in the series mode if there is no electricity remaining in the battery. When there is no electricity remaining in the battery, constant-speed driving in the motor mode at a higher speed is possible to use both the second motor 20 and the first motor 50 rather than using only the first motor 50.

Unlike the hybrid vehicles of the related art, according to the present invention, even if the battery is fully discharged and the first motor cannot be operated, there is no driven load by the second motor 20 in the engine mode and there is also little driven load by the first motor 50 because the capacity of the first motor 50 is small. Accordingly, reduction of engine output by forcible rotation of the first motor 50 can be minimized.

A large difference between the present invention and the hybrid vehicle having one motor in the related art is that the real time series mode can be applied in the present invention. Accordingly, a vehicle can be driven in the electric vehicle mode and the real time series mode regardless of whether electricity remains in a battery even at a high constant speed about 130 km/h at 2,000 rpm. Furthermore, according to the present invention, since a minimum-capacity first motor is used, the driven load by the driving motor can be minimized when a vehicle is driven only by an engine. Furthermore, the first motor is always forcibly rotated, so it is possible to immediately perform regenerative electricity generation without shock.

Meanwhile, another function of the present invention that is not provided by the hybrid vehicles of the related art is that since a clutch is disposed between the first motor and the second motor, it is possible to selectively operate only the first motor, only the second motor, or both the first and second motors in the electric vehicle mode, so the driving motors can be selectively operated, depending on the driving state, and the electric vehicle fuel efficiency (km/kw) can be improved. This can be considered as being similar to COD (cylinder on demand) for improving fuel efficiency in a piston engine.

The actual difference between the present invention and Prius and Bolt having two motors is that the driven load by the first motor is smaller when a vehicle is driven only by the engine. That is, both of first and second motors act as loads, so the driven load is large in Prius and Bolt, but there is no driven load by the second motor and the driven load by the first motor is also minimized in the present invention.

Furthermore, according to the present invention, it is possible to apply the electricity vehicle mode and the real time series mode with a low RPM even in high constant-speed driving. However, Prius or Bolt is driven only by an engine at high constant speed and motors should be rotated with high RPM when the electric vehicle mode is applied, so the electric vehicle fuel efficiency (km/kw) is lower than the present invention. Accordingly, Prius or Bolt is lower in high-speed fuel efficiency than fuel efficiency in cities, but the present invention provides high fuel efficiency in cities and high-speed efficiency.

Although the present invention was described with reference to exemplary embodiments, the embodiments are only examples and it would be apparent to those skilled in the art that the present invention is not limited thereto and may be modified in various ways, and specific technological characteristics may be added on the basis of the spirit of the present invention.

1. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a first clutch (111) and a second clutch (112) constituting a double clutch are disposed on the output shaft (40) between the engine (10) and the second motor (20), and a third clutch (113) connecting or disconnecting power transmitted through the output shaft (40) is disposed between the second motor (20) and the first motor (50).

2. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a second clutch (112) and a first clutch (111) constituting a double clutch are disposed on the output shaft (40) between the second motor (20) and the first motor (50), and a third clutch (113) connecting or disconnecting power transmitted through the output shaft (40) is disposed between the engine (10) and the second motor (20).

3. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a second clutch (112) and a first clutch (111) constituting a dual clutch are disposed on the output shaft (40) between the second motor (20) and the transmission (30), and a third clutch (113) connecting or disconnecting power transmitted through the output shaft (40) is disposed between the dual clutch and the first motor (50).

4. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a first clutch (111) and a second clutch (112) constituting any one of a dual clutch and a double clutch are disposed between the engine (10) and the second motor (20), and a third clutch (113) connecting or disconnecting power generated by the second motor (20) and transmitted through the output shaft (40) is disposed on the output shaft (40) between the second motor (20) and the first motor (50).

5. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a first clutch (111) and a second clutch (112) constituting a dual clutch are disposed on the output shaft (40) between the engine (10) and the second motor, and a third clutch (113) is disposed on the output shaft between the engine (10) and the dual clutch.

6. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), a third clutch (113) is disposed between the engine (10) and the second motor (20), and a second clutch (112) and a first clutch (111) constituting one of a dual clutch and a double clutch is disposed on the output shaft (40) between the second motor (20) and the first motor (50).

7. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), and a first clutch (211), a second clutch (212), and a third clutch (213) constituting a triple clutch are disposed on the output shaft between the engine (10) and the second motor (20).

8. A power transmission structure for a hybrid vehicle having two motor generators and three clutches, the power transmission structure comprising an engine (10), a second motor (20), and an output shaft (40) transmitting power from the engine (10) and the second motor (20) to a transmission (30), wherein the second motor (20) is disposed in parallel with the engine (10), a first motor (50) directly connected to the output shaft (40) of the transmission (30) is disposed between the second motor (20) and the transmission (30), the output shaft (40) is connected to the transmission (30) through a center of the second motor (20), and a third clutch (213), a second clutch (212), and a first clutch (211) constituting a triple clutch are disposed on the output shaft between the second motor (20) and the first motor (50).
